(19) United States
(12) Patent Application Publication
(10) Pub. No.: US 2026/0318045 A1
(43) Pub. Date: Oct. 15, 2026

(54) WORK MACHINE, AND REMOTE OPERATION SUPPORT SYSTEM FOR WORK MACHINE

(71) Applicant: SUMITOMO HEAVY INDUSTRIES, LTD., Tokyo (JP)

(72) Inventors: Hiroaki ISHIDA, Kanagawa (JP); Takashi HOSHINO, Kanagawa (JP); Dotaro USUI, Kanagawa (JP); Shinichiro TSUKAHARA, Kanagawa (JP)

(21) Appl. No.: 19/696,916

(22) Filed: Jun. 3, 2026

Related U.S. Application Data
(63) Continuation of application No. PCT/JP2024/042954, filed on Dec. 4, 2024.

(30) Foreign Application Priority Data
Dec. 6, 2023 (JP) 2023-206066

(51) Int. Cl. E02F 9/24; E02F 9/20; E02F 9/26

(52) U.S. Cl. CPC E02F 9/24; E02F 9/265; E02F 9/205

(57) ABSTRACT

A work machine includes a work attachment. The work machine includes a position/attitude detection device, a storage device, an operation device, a haptics presentation device, a drive device, and a controller including a processor and a memory. The position/attitude detection device detects position/attitude information of the work machine. The storage device stores avoidance condition, which is a condition of position/attitude that should be avoided by the work machine. The operation device generates an operation signal corresponding to an operation performed by an operator of the work machine. The haptics presentation device presents haptics to the operator via the operation device. The drive device moves the work machine in accordance with the operation signal. The controller activates the haptics presentation device when the position/attitude information of the work machine falls under avoidance condition.

### CROSS-REFERENCE TO RELATED APPLICATIONS

This application is a continuation application of International Application No. PCT/JP2024/042954, filed on Dec. 4, 2024, and designating the U.S., which is based upon and claims priority to Japanese Patent Application No. 2023-206066, filed on Dec. 6, 2023, the entire contents of which are incorporated herein by reference.

### BACKGROUND

### Technical Field

The present disclosure relates to a work machine and a remote operation support system for a work machine.

### Background Art

Hitherto, safety devices for construction machines are known. A related-art safety device for construction machines is provided on a construction machine including: a vehicle body configured to travel in accordance with an operation on an operation tool; and a front work machine that is installed on the vehicle body and configured to perform work in accordance with an operation on the operation tool, and prevents the construction machine from coming into contact with an obstacle, such as a worker, an object, and the like, around the construction machine.

This related-art safety device for construction machines includes a reaction force mechanism and a controller for the reaction force mechanism. The reaction force mechanism can apply an operation reaction force, which is a force resisting an operation on the operation tool, to the operation tool when it is operated. The controller for the reaction force mechanism controls the reaction force mechanism to apply an operation reaction force to the operation tool when any obstacle is located in a predetermined dangerous region.

In this related-art safety device for construction machines having the configuration described above, the reaction force mechanism is controlled by the controller for the reaction force mechanism to apply an operation reaction force to the operation tool when any obstacle, such as a worker, an object, and the like, is located in a predetermined dangerous region while the operation tool is operated. The operation reaction force is a force resisting an operation on the operation tool, and makes the operator operating the operation tool feel like he/she is being resisted, such that the operator can sense that the situation is dangerous due to an obstacle being located in the dangerous region.

### SUMMARY

The related-art safety device for construction machines described above determines whether or not the construction machine is in a dangerous state in which the construction machine is close to an obstacle, by using an obstacle detector, such as laser scanning, an ultrasonic transponder, a camera image, a bumper, and the like. However, regardless of the presence or absence of any obstacle, it is desirable to notify the operator of the work machine of a situation that should be avoided by a work machine that is equipped with a work attachment, by presenting haptics to the operator.

The present disclosure provides a work machine that can notify an operator of the work machine of a situation that should be avoided by a work machine equipped with a work attachment by presenting haptics to the operator regardless of the presence or absence of an obstacle, and a remote operation support system for the work machine.

One aspect of the present disclosure is a work machine equipped with a work attachment, the work machine including: a position/attitude detection device configured to detect position/attitude information of the work machine; a storage device configured to store an avoidance condition, which is a condition of a position/attitude that should be avoided by the work machine; an operation device configured to generate an operation signal corresponding to an operation performed by an operator of the work machine; a haptics presentation device configured to present haptics to the operator via the operation device; a drive device configured to move the work machine in accordance with the operation signal; and a controller including a processor and a memory d configured to activate the haptics presentation device when the position/attitude information falls under the avoidance condition.

Another aspect of the present disclosure is a remote operation support system for a work machine, including: a work machine including a work attachment; and a remote operation support device configured to remotely operate the work machine, wherein the remote operation support system includes: a position/attitude detection device configured to detect position/attitude information of the work machine; a storage device configured to store an avoidance condition, which is a condition of a position/attitude that should be avoided by the work machine; an operation device configured to generate an operation signal corresponding to an operation performed by an operator of the work machine; a haptics presentation device configured to present haptics to the operator via the operation device; a drive device configured to move the work machine in accordance with the operation signal; and a controller including a processor and a memory and configured to activate the haptics presentation device when the position/attitude information falls under the avoidance condition.

According to the above aspects of the present disclosure, it is possible to provide a work machine that can notify an operator of the work machine of a situation that should be avoided by the work machine by presenting haptics to the operator regardless of the presence or absence of an obstacle, and a remote operation support system for the work machine.

### BRIEF DESCRIPTION OF THE DRAWINGS

FIG. 1 is a diagram showing an embodiment of a work machine and a remote operation support system according to the present disclosure;

FIG. 2 includes a top view and a left-side view showing an example of an operation device of FIG. 1;

FIG. 3 includes a top view and a right-side view showing another example of the operation device of FIG. 1;

FIG. 4 is a side view of an excavator as an example of the work machine of FIG. 1;

FIG. 5 is a view showing a configuration example of a drive system mounted on the excavator of FIG. 4;

FIG. 6 is a view showing a configuration example of an electric system mounted on the excavator of FIG. 4;

FIG. 7 is an oblique view showing an example of an avoidance condition that should be avoided by the excavator of FIG. 4;

FIG. 8 is a flowchart showing an operation of control devices of the work machine and the system of FIG. 1;

FIG. 9 is a side view showing another example of an avoidance condition that should be avoided by the excavator of FIG. 4; and

FIG. 10 is a side view of a forestry machine as an example of the work machine of FIG. 1.

### DETAILED DESCRIPTION OF THE INVENTION

Hereinafter, embodiments for carrying out the invention will be described with reference to the drawings.

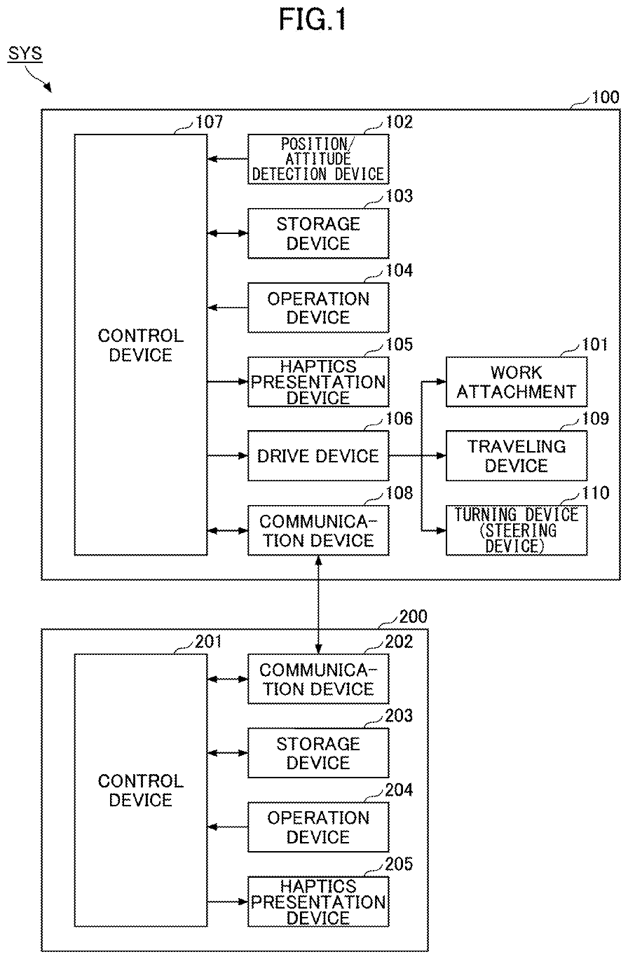

FIG. 1 is a block diagram showing an embodiment of a work machine and a remote operation support system for a work machine according to the present disclosure. A remote operation support system SYS for a work machine of the present embodiment includes a work machine 100 and a remote operation support device 200. The remote operation support system SYS for a work machine may include, for example, a network server (not shown).

The work machine 100 is a work machine, such as an excavator, a forestry machine, a wheel loader, a forklift, a crane, or the like that is equipped with a work attachment 101 for performing predetermined work, such as excavation, transportation, hoisting, or the like.

When the work machine 100 is an excavator, the work attachment 101 includes, for example, a boom, an arm, a bucket, and the like. When the work machine 100 is a forestry machine, the work attachment 101 includes, for example, a boom, an arm, a harvester link, a roller harvester device, and the like. When the work machine 100 is a wheel loader, the work attachment 101 includes, for example, an arm and a bucket. When the work machine 100 is a forklift, the work attachment 101 includes, for example, a fork, a backrest, a lift chain, a mast, and the like. When the work machine 100 is a crane, the work attachment 101 includes, for example, a boom, a jib, a hook, a guy line, and the like.

The work machine 100 includes, for example, a position/attitude detection device 102, a storage device 103, an operation device 104, a haptics presentation device 105, a drive device 106, and a control device 107. The work machine 100 also includes, for example, a communication device 108, a traveling device 109, and a turning device 110. When the work machine 100 is an excavator, a forestry machine, or a crane, the work machine 100 includes the turning device 110. However, when the work machine 100 is a work machine other than an excavator, a forestry machine, and a crane, the work machine 100 may include a steering device instead of the turning device 110.

The position/attitude detection device 102 is a device for detecting position/attitude information of the work machine 100. The position/attitude detection device 102 detects, for example, the position and the attitude of the work machine 100 including the position and the attitude of the work attachment 101, and outputs the detection result to the control device 107 as position/attitude information of the work machine 100.

The position/attitude detection device 102 includes, for example, a Global Satellite Navigation System (GNSS) receiver for acquiring position information of the work machine 100. The position/attitude detection device 102 also includes, for example, sensors, such as an angle sensor, a stroke sensor, an inertial sensor, and the like, attached to the work machine 100 including the work attachment 101.

The storage device 103 includes, for example, a volatile storage device, such as a RAM and the like, and a nonvolatile storage device, such as a ROM, a flash memory, a magnetic storage device, or the like. The storage device 103 stores avoidance conditions. Although the details will be described later, the avoidance conditions are conditions of a position/attitude (a position and an attitude) that should be avoided by the work machine 100.

The operation device 104 generates, for example, an operation signal corresponding to an operation performed by an operator of the work machine 100 and outputs the generated signal to the control device 107. The operation device 104 includes, for example, an operation lever, an operation pedal, an operation button, an operation dial, an operation switch, and the like installed in a driver's chamber of the work machine 100. The operation device 104 may also be, for example, a portable controller or a joystick.

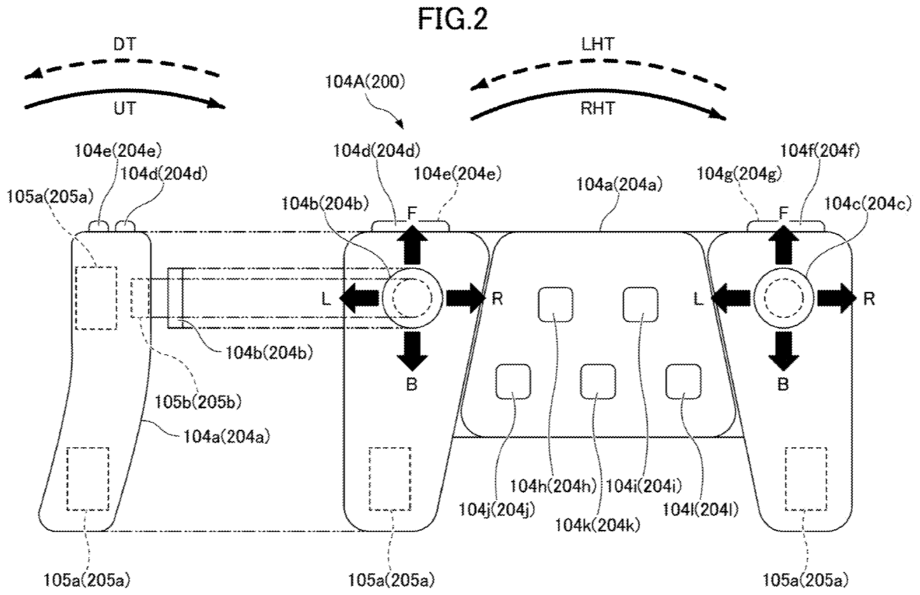

FIG. 2 is a top view showing an example of the operation device 104 of FIG. 1. A portable controller 104A shown in FIG. 2 is an operation device 104 that is operated by an operator of the work machine 100 by gripping it with both hands, and is connected to the control device 107 by cable or wirelessly. The portable controller 104A includes, for example, a housing 104a, a left operation lever 104b, a right operation lever 104c, and a plurality of operation buttons 104d to 1041. The portable controller 104A may be a ready-made portable controller used for, for example, a game console and the like.

For example, the housing 104a has its longer direction extending in a left-right direction in a state of being gripped by an operator, and includes a pair of gripping parts that are gripped by the operator with his/her left hand and right hands on the left end and the right end, respectively. The pair of gripping parts of the housing 104a extend farther backward than the center part of the housing 104a, such that the palms of the operator can fit the gripping parts in a state in which the operator grips the pair of gripping parts by placing the thumbs of his/her left hand and right hand on the left operation lever 104b and the right operation lever 104c, respectively.

The left operation lever 104b is provided, for example, on a front end part of the left gripping part of the operation device 104. The right operation lever 104c is provided, for example, on a front end part of the right gripping part of the operation device 104. The left operation lever 104b and the right operation lever 104c detect the amounts of the operations performed by the operator on the portable controller 104A in respective operation directions including the right direction R, the left direction L, the front direction F, and the back direction B, and output the detection results to the control device 107.

The respective operation directions in which and the amount of operations by which the left operation lever 104b and the right operation lever 104c are operated are associated with, for example, the movements and the speeds of the work attachment 101 and the turning device 110 or the steering device of the work machine 100.

The operation button 104d and the operation button 104e are provided, for example, to project forward from the front end surface of the gripping part located on the left side of the housing 104a, and are disposed adjacent to each other vertically. The operation button 104f and the operation button 104g are provided, for example, to project forward from the front end surface of the gripping part located on the right side of the housing 104a, and are disposed adjacent to each other vertically. These operation buttons 104d to 104g are associated with, for example, movements of the traveling device 109 of the work machine 100, such as a forward movement, a backward movement, a direction change, and the like.

The operation buttons 104h to 104l are provided, for example, to project upward from the upper end surface of the center part that is between the gripping parts located on the left and right sides of the housing 104a. The operations on the operation buttons 104h to 104l are associated with, for example, turning ON or OFF of a start switch, a light, a horn, other auxiliary equipment, and the like of the work machine 100.

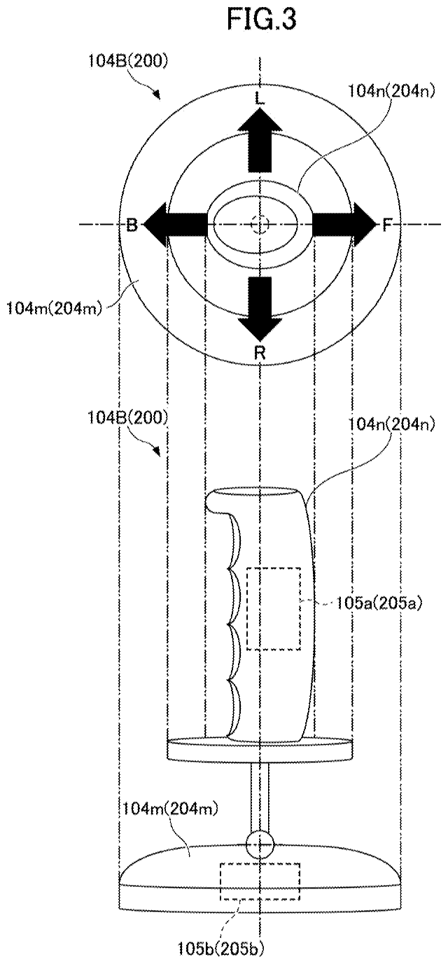

FIG. 3 includes a top view and a side view showing another example of the operation device 104 of FIG. 1. A joystick 104B shown in FIG. 3 is an operation device 104 that is operated by the operator of the work machine 100 by gripping it with one hand, and is connected to the control device 107 by cable or wirelessly. The operation device 104 shown in FIG. 1 includes, for example, a pair of joysticks 104B for the left hand and the right hand.

Each of the joysticks 104B includes, for example, a pedestal part 104m and a stick 104n that is tiltably attached to the pedestal part 104m. The joystick 104B may also include, for example, an operation button, an operation switch, an operation dial, and the like, similarly to the portable controller 104A.

The joystick 104B detects, for example, the amount of an operation performed by the operator on the stick 104n with respect to the pedestal part 104m in respective operation directions including the right direction R, the left direction L, the front direction F, and the back direction B, and outputs the detection result to the control device 107. Each operation direction in which and the amount of an operation by which the joystick 104B is operated are associated with, for example, the movements and the speeds of the work attachment 101, and the turning device 110 or the steering device of the work machine 100.

The haptics presentation device 105 shown in FIG. 1 presents haptics to the operator via the operation device 104. Here, haptics is a sense of force that is received by the operator of the work machine 100 from the operation device 104 when the operator operates the operation device 104. The haptics presentation device 105 includes, for example, at least one of a haptics presentation actuator or a pseudo haptics presentation actuator.

When the operation device 104 includes an operation lever installed in the driver's chamber of the work machine 100, the haptics presentation device 105 includes a haptics presentation actuator that presents haptics to the operator via the operation lever. The haptics presentation actuator of the haptics presentation device 105 presents, for example, haptics in a direction opposite to the direction in which the operation lever is operated by the operator, or haptics in a direction in which the work machine 100 would overcome an avoidance condition to the operator via the operation lever. The haptics presentation actuator can be composed of, for example, an electric motor, a hydraulic cylinder, an air cylinder, or the like.

As shown in FIG. 2, when the operation device 104 is the portable controller 104A, the haptics presentation device 105 includes, for example, a pseudo haptics presentation actuator 105a for presenting pseudo or virtual haptics (hereinafter referred to as “pseudo haptics”) to the operator gripping the housing 104a. For example, the pseudo haptics presentation actuator 105a is mounted on the portable controller 104A, and presents pseudo haptics in a predetermined direction to the operator of the portable controller 104A by generating a pseudo haptics vibration, which is a vibration having a waveform that is asymmetrical with respect to a direction in which the pseudo haptics is presented.

The portable controller 104A may include, for example, a plurality of pseudo haptics presentation actuators 105a. Specifically, the portable controller 104A may include, for example, pseudo haptics presentation actuators 105a on the left and right gripping parts of the housing 104a, respectively. Thus, for example, by causing the left and right pseudo haptics presentation actuators 105a to generate pseudo haptics toward the front and the back of the housing 104a, respectively, it is possible to present, to the operator, haptics in a clockwise RHT or counterclockwise LHT rotational direction about the housing 104a.

The portable controller 104A may also include, for example, pseudo haptics presentation actuators 105a on the front end part and the back end part of the housing 104a, respectively. Thus, for example, it is possible to cause the front and back pseudo haptics presentation actuators 105a to generate pseudo haptics toward above and under the housing 104a, respectively. As a result, haptics in a rotational direction in which the front end part of the housing 104a would lift in the upward direction UT or would be pushed in the downward direction DT can be presented to the operator gripping the operation device 104.

When the operation device 104 is the portable controller 104A, the haptics presentation device 105 includes haptics presentation actuators 105b for presenting haptics to the operator via, for example, the left operation lever 104b and the right operation lever 104c. For example, the haptics presentation actuators 105b present, to the operator via the left operation lever 104b and the right operation lever 104c, haptics in a direction opposite to the direction in which the left operation lever 104b and the right operation lever 104c are operated by the operator, or haptics in a direction in which the work machine 100 would overcome an avoidance condition.

When the operation device 104 is the joystick 104B, as shown in FIG. 3, the haptics presentation device 105 includes a haptics presentation actuator 105b for presenting haptics to the operator via, for example, the stick 104n. For example, the haptics presentation actuator 105b presents to the operator via the stick 104n, haptics in a direction opposite to the direction in which the stick 104n is operated by the operator, or haptics in a direction in which the work machine 100 would overcome an avoidance condition. In this case as well, the haptics presentation actuator 105b may be composed of, for example, an electric motor, a hydraulic cylinder, an air cylinder, or the like.

When the operation device 104 is the joystick 104B, the haptics presentation device 105 may include, for example, a pseudo haptics presentation actuator 105a in the gripping part of the stick 104n. Thus, for example, the haptics presentation device 105 can present, to the operator via the gripping part of the stick 104n, pseudo haptics in a direction opposite to the direction in which the stick 104n is operated by the operator, or pseudo haptics in a direction in which the work machine 100 would overcome an avoidance condition.

The drive device 106 shown in FIG. 1 moves the work machine 100 in accordance with an operation signal that is output from the operation device 104 and input into the control device 107. Specifically, when an operation signal is input from the operation device 104, the control device 107 outputs a control signal corresponding to the operation signal to the drive device 106. The drive device 106 drives the work machine 100 in accordance with the control signal input from the control device 107.

The drive device 106 includes, for example, a power source, such as an internal combustion engine, an electric motor, or the like, a hydraulic pump driven by the power source, a control valve for controlling the direction and the flow rate of a hydraulic oil that is pressure-fed from the hydraulic pump, and hydraulic actuators driven by the hydraulic oil supplied via the control valve. The control valve is controlled in accordance with, for example, a control signal that is input from the control device 107 into the drive device 106. The hydraulic actuators include, for example, a hydraulic motor and a hydraulic cylinder, and drive the work attachment 101, the traveling device 109, and the turning device 110 or the steering device.

The control device 107 is a controller composed of one or more microcontrollers including, for example, a central processing unit (CPU), a memory, such as ROM, a RAM, and the like, a timer, and an input/output unit. For example, the control device 107 acquires detection results from various sensors including the position/attitude detection device 102 and performs various calculations by executing a program stored in the memory or the storage device 103, and controls various parts of the work machine 100.

In the work machine 100 of the present embodiment, the control device 107 activates the haptics presentation device 105 when the position/attitude information of the work machine 100 based on a detection result of the position/attitude detection device 102 falls under a predetermined avoidance condition described later.

The communication device 108 is, for example, a wireless communication device mounted on the work machine 100, and is connected to the remote operation support device 200 through a wireless communication line to be able to perform information communication. When the remote operation support device 200 is installed in a remote operation chamber or the like at a remote location away from the work site of the work machine 100, the communication device 108 may be connected to the remote operation support device 200 to be able to perform information communication through, for example, a wireless communication line, a wired communication line, a server, and the like. In this case, the remote operation support system SYS for a work machine may include a server.

The traveling device 109 is driven by, for example, a drive device 106 to cause the work machine 100 to travel. Specifically, the traveling device 109 includes, for example, a plurality of wheels driven by a hydraulic motor of the drive device 106, a lower traveling body including crawlers, or the like.

The turning device 110 is driven by, for example, the drive device 106 to turn the work machine 100. Specifically, the turning device 110 is driven by, for example, a turning hydraulic motor of the drive device 106 to turn the upper turning body of the work machine 100 mounted on the traveling device 109.

The steering device is driven by, for example, the drive device 106 to change the traveling direction of the work machine 100. Specifically, the steering device includes, for example, an articulate part for tilting the front body of the work machine 100 relative to the back body by extending or contracting a steering cylinder of the drive device 106.

The remote operation support device 200 is a device for remotely operating the work machine 100. For example, as described above, the remote operation support device 200 is installed in a remote operation chamber at a remote location away from the work site of the work machine 100. Further, as shown in FIGS. 2 and 3, for example, the remote operation support device 200 may be configured as a portable controller or a joystick carried by an operator who operates the work machine 100 from outside the driver's chamber thereof on the work site of the work machine 100.

The remote operation support device 200 includes, for example, a control device 201, a communication device 202, a storage device 203, an operation device 204, and a haptics presentation device 205.

The control device 201 is a controller composed of, for example, one or more microcontrollers including a CPU, a memory, such as a ROM, a RAM, and the like, a timer, and an input/output unit. The control device 201 controls each part of the remote operation support device 200 by, for example, executing a program stored in the memory or the storage device 203.

In the remote operation support system SYS for a work machine according to the present embodiment, the control device 201 activates the haptics presentation device 205 when, for example, position/attitude information of the work machine 100 acquired from the work machine 100 via the communication device 202 falls under a predetermined avoidance condition described later.

The communication device 202 is, for example, a wireless communication device provided in the remote operation support device 200, and is connected to the communication device 108 of the work machine 100 through a wireless communication line to be able to perform information communication. As described above, when the remote operation support device 200 is installed in a remote location, such as a remote operation chamber and the like, the communication device 202 may be connected to the communication device 108 of the work machine 100 to be able to perform information communication through, for example, a wireless communication line, a wired communication line, a server, and the like.

The storage device 203 includes, for example, a volatile storage device, such as a RAM and the like, and a nonvolatile storage device, such as a ROM, a flash memory, a magnetic storage device, or the like. The storage device 203 stores avoidance conditions, which are conditions of positions and attitudes that should be avoided by the work machine 100, similarly to the storage device 103 of the work machine 100.

The operation device 204 generates, for example, an operation signal corresponding to an operation performed by an operator of the work machine 100, and outputs the generated operation signal to the control device 201. The control device 201 transmits the operation signal input from the operation device 204 to the communication device 108 of the work machine 100 via the communication device 202. The control device 107 of the work machine 100 controls the drive device 106 based on the operation signal received via the communication device 108 to move the work attachment 101, the traveling device 109, and the turning device 110 or the steering device of the work machine 100.

The operation device 204 has a configuration similar to, for example, the operation lever, the operation pedal, the operation button, the operation dial, and the operation switch installed in the driver's chamber of the work machine 100, and is installed in a remote operation chamber at a remote location away from the work site of the work machine 100. As shown in FIG. 2 or FIG. 3, the remote operation support device 200 may be configured as, for example, a portable controller or a joystick used at a remote location or a work site.

When the remote operation support device 200 is configured as the portable controller shown in FIG. 2, the operation device 204 may have a configuration similar to, for example, the portable controller 104A of the work machine 100. Specifically, the operation device 204 includes, for example, a housing 204a, a left operation lever 204b, a right operation lever 204c, and a plurality of operation buttons 204d to 204l. Since the configurations of these parts of the operation device 204 are similar to the configurations of the corresponding parts of the portable controller 104A, detailed description thereof will be omitted.

When the remote operation support device 200 is configured as the joystick shown in FIG. 3, the operation device 204 may have a configuration similar to, for example, the joystick 104B of the work machine 100. Specifically, the operation device 204 includes, for example, a pedestal part 204m and a stick 204n. Since the configurations of these parts of the operation device 204 are similar to the configurations of the corresponding parts of the joystick 104B, detailed description thereof will be omitted. The remote operation support device 200 may include, for example, an operation button, an operation switch, an operation dial, and the like, similarly to the portable controller 104A.

The haptics presentation device 205 presents haptics to the operator via the operation device 204. When the operation device 204 includes a component similar to the operation lever or the like installed in the driver's chamber of the work machine 100, the haptics presentation device 205 includes a haptics presentation actuator that presents haptics to the operator via the operation lever. The haptics presentation actuator of the haptics presentation device 205 presents to the operator via the operation lever, for example, haptics in a direction opposite to the direction in which the operation lever is operated by the operator, or haptics in a direction in which the work machine 100 would overcome an avoidance condition. The haptics presentation actuator may be composed of, for example, an electric motor, a hydraulic cylinder, an air cylinder, or the like.

When the remote operation support device 200 is configured as the portable controller shown in FIG. 2, the haptics presentation device 205 includes, for example, a plurality of pseudo haptics presentation actuators 205a mounted on the housing 204a, similarly to the portable controller 104A of the work machine 100. Thus, the haptics presentation device 205 can present, to the operator of the operation device 204, pseudo haptics in a predetermined direction, including the clockwise RHT or counterclockwise LHT rotational direction about the housing 204a, or a direction in which the front end of the housing 204a is lifted in the upward direction UT or is pushed down in the downward direction DT.

When the remote operation support device 200 is configured as the joystick shown in FIG. 3, the haptics presentation device 205 includes, for example, a haptics presentation actuator 205b for presenting haptics to the operator via the stick 204n. The haptics presentation actuator 205b presents, to the operator via the stick 204n, for example, haptics in a direction opposite to the direction in which the stick 204n is operated by the operator, or haptics in a direction in which the work machine 100 would overcome an avoidance condition. Also in this case, the haptics presentation actuator 205b may be composed of, for example, an electric motor, a hydraulic cylinder, an air cylinder, or the like.

When the remote operation support device 200 is configured as the joystick shown in FIG. 3, the haptics presentation device 205 may include, for example, a pseudo haptics presentation actuator 205a in the gripping part of the stick 204n. Thus, the haptics presentation device 205 can present to the operator via the gripping part of the stick 204n, for example, pseudo haptics in a direction opposite to the direction in which the stick 204n is operated by the operator, or pseudo haptics in a direction in which the work machine 100 can overcome an avoidance condition.

Hereinafter, an embodiment in which the work machine 100 is an excavator or a forestry machine will be described.

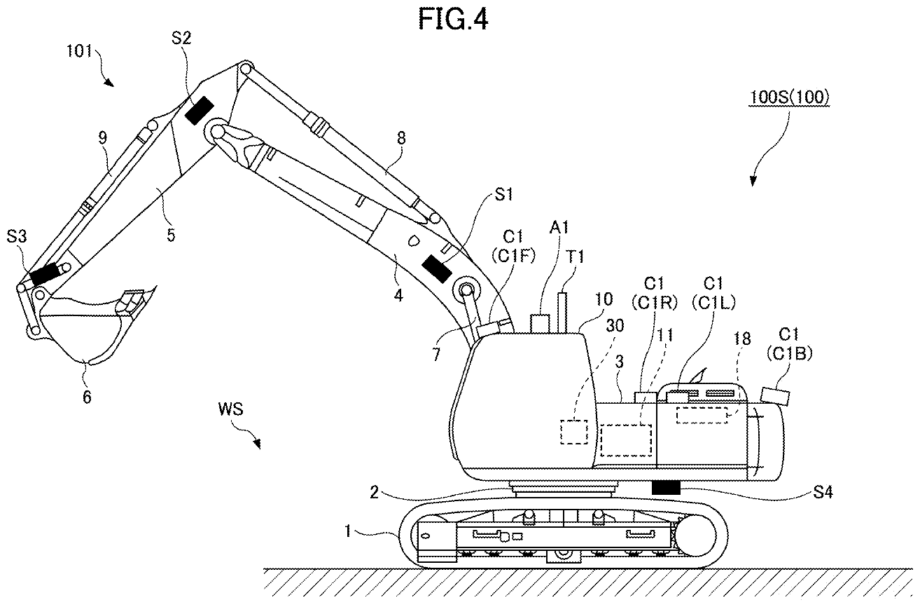

FIG. 4 is a side view of an excavator 100S as an example of the work machine 100. An upper turning body 3 is turnably mounted on a lower traveling body 1 of the excavator 100S corresponding to the traveling device 109 of FIG. 1 via a turning mechanism 2 corresponding to the turning device 110 of FIG. 1. A boom 4 is attached to the upper turning body 3. An arm 5 is attached to the tip of the boom 4, and a bucket 6 as an end attachment is attached to the tip of the arm 5.

The boom 4, the arm 5, and the bucket 6 constitute an excavation attachment that is an example of the work attachment 101 of FIG. 1. The boom 4 is driven by a boom cylinder 7, the arm 5 is driven by an arm cylinder 8, and the bucket 6 is driven by a bucket cylinder 9. The boom cylinder 7, the arm cylinder 8, and the bucket cylinder 9 are included in the drive device 106 of FIG. 1.

A boom angle sensor S1 is attached to the boom 4, an arm angle sensor S2 is attached to the arm 5, and a bucket angle sensor S3 is attached to a bucket link. A turning angular velocity sensor S4 is attached to the upper turning body 3. The boom angle sensor S1, the arm angle sensor S2, the bucket angle sensor S3, and the turning angular velocity sensor S4 are included in the position/attitude detection device 102 of FIG. 1.

The boom angle sensor S1 is one of the attitude detection sensors, and is configured to detect the pivoting angle of the boom 4. In the present embodiment, the boom angle sensor S1 is a stroke sensor for detecting the stroke amount of the boom cylinder 7, and derives the pivoting angle of the boom 4 about a boom foot pin connecting the upper turning body 3 and the boom 4 based on the stroke amount of the boom cylinder 7.

The arm angle sensor S2 is one of the attitude detection sensors, and is configured to detect the pivoting angle of the arm 5. In the present embodiment, the arm angle sensor S2 is a stroke sensor for detecting the stroke amount of the arm cylinder 8, and derives the pivoting angle of the arm 5 about a connecting pin connecting the boom 4 and the arm 5 based on the stroke amount of the arm cylinder 8.

The bucket angle sensor S3 is one of the attitude detection sensors, and is configured to detect the pivoting angle of the bucket 6. In the present embodiment, the bucket angle sensor S3 is a stroke sensor for detecting the stroke amount of the bucket cylinder 9, and derives the pivoting angle of the bucket 6 about a connecting pin connecting the arm 5 and the bucket 6 based on the stroke amount of the bucket cylinder 9.

The turning angular velocity sensor S4 is configured to detect the turning angular velocity of the upper turning body 3. In the present embodiment, the turning angular velocity sensor S4 is a gyro sensor. The turning angular velocity sensor S4 may be configured to calculate a turning angle based on the turning angular velocity. The turning angular velocity sensor S4 may be composed of any other sensor, such as a rotary encoder and the like.

A cabin 10 serving as a driver's chamber, an engine 11, a positioning device 18, a sound collection device A1, image capture devices C1, a communication device T1, and the like are mounted on the upper turning body 3. A controller 30 is mounted in the cabin 10. A driver's seat, an operation device, and the like are installed in the cabin 10. However, the excavator 100S may be an unmanned excavator from which the cabin 10 is omitted.

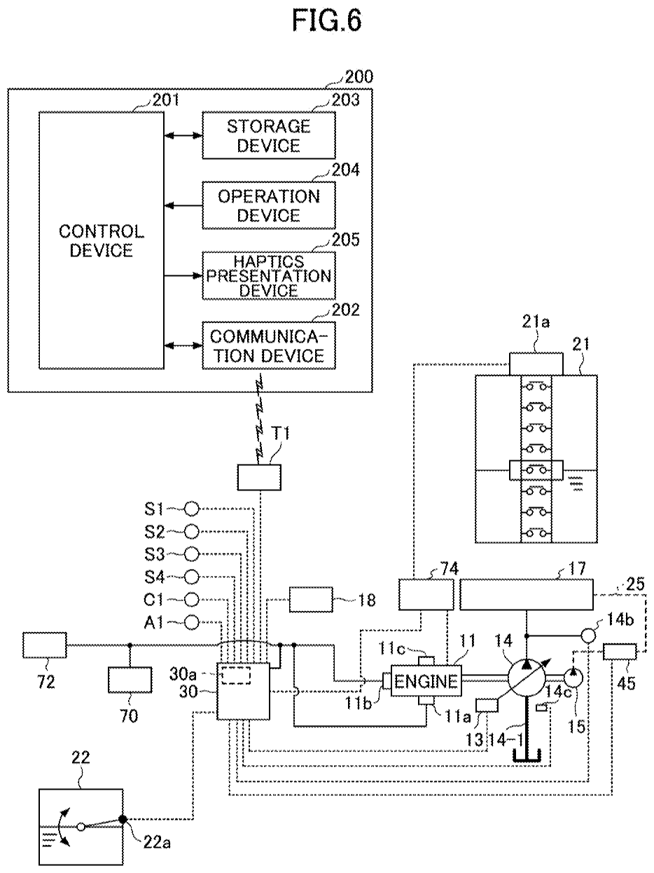

The engine 11 is a drive source of the excavator 100S. In the present embodiment, the engine 11 is a diesel engine. An output shaft of the engine 11 is coupled to an input shaft of each of a main pump 14 and a pilot pump 15 (see FIG. 6). The engine 11 is included in the drive device 106 of FIG. 1.

The positioning device 18 is configured to measure the position of the excavator 100S. In the present embodiment, the positioning device 18 is a GNSS compass, and is configured to measure the position and the orientation of the upper turning body 3. The positioning device 18 is included in the position/attitude detection device 102 of FIG. 1.

The sound collection device A1 is configured to collect sounds generated around the excavator 100S. In the present embodiment, the sound collection device A1 is a microphone attached to the upper turning body 3.

The image capture devices C1 are configured to capture an image of the surroundings of the excavator 100S. In the present embodiment, the image capture devices C1 include a back camera C1B attached to the back end of the upper surface of the upper turning body 3, a front camera C1F attached to the front end of the upper surface of the cabin 10, a left camera C1L attached to the left end of the upper surface of the upper turning body 3, and a right camera C1R attached to the right end of the upper surface of the upper turning body 3. The image capture devices C1 may be an omnidirectional camera installed at a predetermined position in the cabin 10. The predetermined position is, for example, a position corresponding to the positions of the eyes of the operator seated in the driver's seat installed in the cabin 10.

The communication device T1 corresponding to the communication device 108 of FIG. 1 is configured to control communications with devices external to the excavator 100S. In the present embodiment, the communication device T1 is configured to control wireless communications between the communication device T1 and devices external to the excavator 100S through a wireless communication network. The controller 30 corresponding to the control device 107 of FIG. 1 is a calculation device for executing various calculations, as described above.

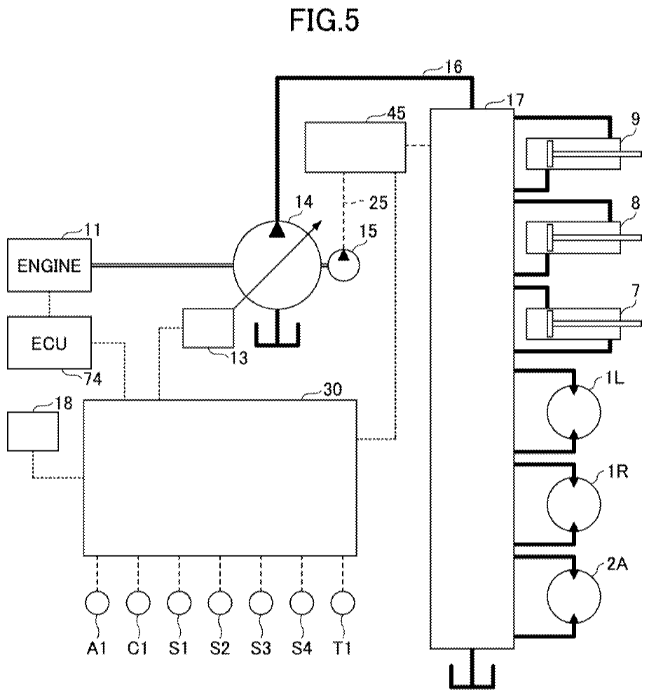

FIG. 5 is a block diagram showing a configuration example of a drive system mounted on the excavator 100S of FIG. 4. In FIG. 5, mechanical power transmission lines are indicated by double lines, hydraulic oil lines are indicated by thick solid lines, pilot lines are indicated by broken lines, and electric control lines are indicated by dotted lines.

The drive system of the excavator 100S corresponding to the drive device 106 of FIG. 1 includes the engine 11, a regulator 13, the main pump 14, the pilot pump 15, a control valve unit 17, an engine control unit 74, a solenoid valve unit 45, and the like. The engine 11 is driven and controlled by the engine control unit 74.

The main pump 14 supplies a hydraulic oil to the control valve unit 17 through hydraulic oil lines 16. In the present embodiment, the main pump 14 is a swash plate-type variable displacement hydraulic pump.

The regulator 13 is configured to control the discharge amount of the main pump 14. In the present embodiment, the regulator 13 is configured to adjust the swash plate tilt angle of the main pump 14 in accordance with the discharge pressure of the main pump 14 or a control signal from the controller 30. The discharge amount (displacement volume) of the main pump 14 per one rotation is controlled by the regulator 13.

The pilot pump 15 is configured to supply the hydraulic oil to various hydraulic control devices through pilot lines 25. In the present embodiment, the pilot pump 15 is a fixed displacement hydraulic pump, However, the pilot pump 15 may be omitted. In this case, the function of the pilot pump 15 may be implemented by the main pump 14. That is, the main pump 14 may have a function for supplying the hydraulic oil to the solenoid valve unit 45 and the like via a throttle or the like, separately from the function for supplying the hydraulic oil to the control valve unit 17.

The control valve unit 17 is configured to supply the hydraulic oil received from the main pump 14 selectively to one or a plurality of hydraulic actuators. In the present embodiment, the control valve unit 17 includes a plurality of control valves corresponding to the plurality of hydraulic actuators. The control valve unit 17 can supply the hydraulic oil discharged from the main pump 14 selectively to one or a plurality of hydraulic actuators,

The hydraulic actuators include, for example, a boom cylinder 7, an arm cylinder 8, a bucket cylinder 9, a left traveling hydraulic motor 1L, a right traveling hydraulic motor 1R, and a turning hydraulic motor 2A. These hydraulic actuators are included in the drive device 106 of FIG. 1.

The controller 30 is configured to control the solenoid valve unit 45 based on an operation signal received via the communication device T1. In the present embodiment, an operation signal may be transmitted from the remote operation support device 200 installed in a remote operation chamber at a remote location away from the work site WS, or may be input via the operation device 104 that is operated by an operator from inside the cabin 10 or outside the cabin 10 at the work site WS of the excavator 100S.

The solenoid valve unit 45 includes a plurality of solenoid valves disposed on the respective pilot lines 25 connecting the pilot pump 15 and pilot ports of the respective control valves in the control valve unit 17.

In this manner, the controller 30 can realize raising and lowering of the boom 4, opening and closing of the arm 5, opening and closing of the bucket 6, turning of the upper turning body 3, traveling of the lower traveling body 1, and the like in accordance with operation signals input via the operation device 204 of the remote operation support device 200 or the operation device 104 of the work machine 100.

FIG. 6 is a block diagram showing a configuration example of an electric system mounted on the excavator 100S of FIG. 4. The engine 11 is connected to the engine control unit 74 as shown in FIG. 5. Various data indicating the state of the engine 11 are transmitted from the engine control unit 74 to the controller 30. The controller 30 is configured to store the various data indicating the state of the engine 11 in a memory 30a.

A battery 70 is configured to supply electric power to various electric loads mounted on the excavator 100S. An alternator 11a (generator), a starter 11b, the controller 30, electric equipment 72, and the like are configured to operate by the electric power stored in the battery 70. The starter 11b is driven by the electric power stored in the battery 70, and configured to start the engine 11. The battery 70 is configured to be charged with electric power generated by the alternator 11a.

A water temperature sensor 11c transmits data related to the temperature of the engine cooling water to the controller 30. The regulator 13 transmits data related to the swash plate tilt angle to the controller 30. A discharge pressure sensor 14b transmits data related to the discharge pressure of the main pump 14 to the controller 30. The positioning device 18 transmits data related to the position of the excavator 100S to the controller

An oil temperature sensor 14c is provided on piping 14-1 between the main pump 14 and a hydraulic oil tank storing the hydraulic oil to be sucked by the main pump 14. The oil temperature sensor 14c transmits data related to the temperature of the hydraulic oil flowing in the piping 14-1 to the controller 30.

A urea solution remaining amount sensor 21a provided to a urea solution tank 21 transmits data related to the remaining amount of the urea solution to the controller 30. A fuel remaining amount sensor 22a provided to a fuel tank 22 transmits data related to the remaining amount of the fuel to the controller 30.

The communication device T1 corresponding to the communication device 108 in FIG. 1 is configured to exchange information with the communication device 202 of the remote operation support device 200 via wireless communication. In the present embodiment, the communication device T1 and the communication device 202 are configured to exchange information through a 5^{th} generation mobile communication line (5G line), an LTE line, a satellite line, and the like.

For example, the remote operation support device 200, and a sound output device, an indoor image capture device, an image generation device, a display device, and the like (not shown) are installed in the remote operation chamber in a remote location away from the work site.

The sound output device is configured to output a sound. In the present embodiment, the sound output device is a loudspeaker, and is configured to reproduce a sound collected by the sound collection device A1 attached to the excavator 100S.

The indoor image capture device is configured to capture an image of the interior of the remote operation chamber. In the present embodiment, the indoor image capture device is a camera installed inside the remote operation chamber, and is configured to capture an image of an operator seated in the driver's seat.

The display device is configured to display information regarding the surrounding situation of the excavator 100S. The display device is, for example, a multi-display composed of nine monitors on three vertical columns and three horizontal rows, and is configured to display the state of the space in front, on the left, and on the right of the excavator 100S. Each monitor is a liquid crystal monitor, an organic EL monitor, or the like. However, the display device may be composed of one or a plurality of curved monitors, or may be composed of a projector.

The display device may be a display device wearable by an operator, For example, the display device may be a head-mounted display, and may be configured to exchange information with the control device 201 by wireless communication. The head-mounted display may be connected to the control device 201 by cable. The head-mounted display may be a see-through head-mounted display or a non-see-through head-mounted display. The head-mounted display may be a monocular head-mounted display or a binocular head-mounted display.

The display device is configured to display an image for allowing the operator in the remote operation chamber to visually recognize the surroundings of the excavator 100S. That is, the display device displays the image such that the operator can confirm the surroundings of the excavator 100S as if the operator were in the cabin 10 of the excavator 100S, even though the operator is in the remote operation chamber.

The image generation device is a device for generating an image for supporting a remote operation of the excavator 100S as the work machine 100 including an excavation attachment as the work attachment 101, as described above. The image generation device generates an image captured by the image capture devices C1 on the work site WS where the excavator 100S works, and displays it on the display device.

For example, the operation device 204 of the remote operation support device 200 installed in the remote operation chamber can have a configuration similar to that of the operation device 104 in the cabin 10 of the excavator 100S. Specifically, a driver's seat similar to the driver's seat in the cabin 10 of the excavator 100S is placed in the remote operation chamber, and a left console box and a right console box are placed on the left and right sides of the driver's seat, respectively. A left operation lever and a right operation lever are disposed on the front ends of the upper surfaces of the right and left console boxes, respectively. A traveling lever and a traveling pedal are disposed in front of the driver's seat. Furthermore, an engine rotational speed adjustment dial is disposed in the center of the upper surface of the right console box. The left operation lever, the right operation lever, the traveling lever, the traveling pedal, and the engine rotational speed adjustment dial constitute the operation device 204 of the remote operation support device 200.

The remote operation support device 200 may be composed of, for example, the portable controller shown in FIG. 2 or the joystick shown in FIG. 3. In this case, the remote operation support device 200 may be located in the remote operation chamber in a remote location away from the work site WS of the excavator 100S, or may be carried by an operator operating the excavator 100S at the work site WS.

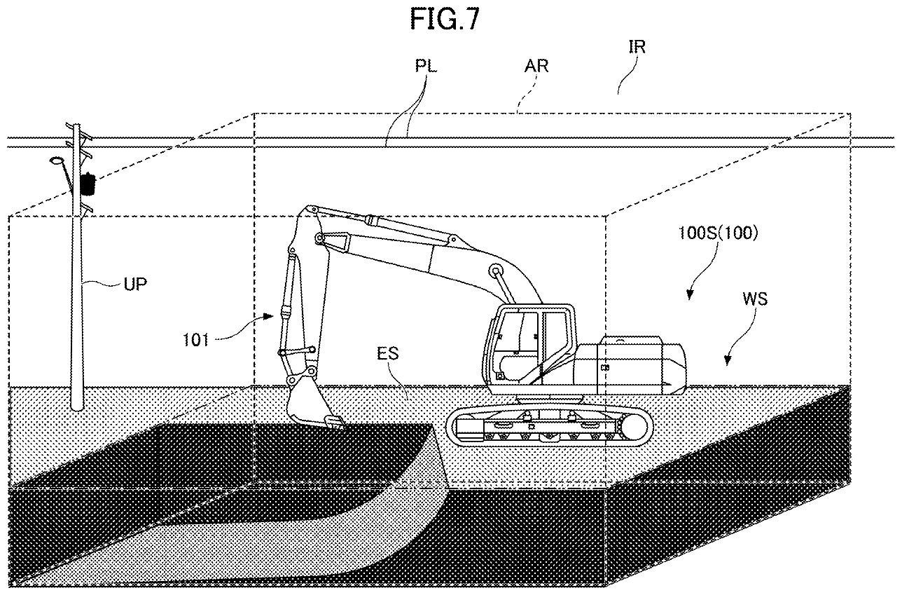

FIG. 7 is an oblique view showing an example of an avoidance condition that should be avoided by the excavator 100S as an example of the work machine 100 shown in FIG. 1. In the example shown in FIG. 7, at the work site WS where the excavator 100S performs excavation work, a three-dimensional appropriate range AR is set in advance as a range in which the excavator 100S can avoid contact with surrounding obstacles and can move within a movable range of the work machine 100 including the work attachment 101. The appropriate range AR is stored in advance in, for example, at least one of the storage device 103 of the excavator 100S or the storage device 203 of the remote operation support device 200.

In the example shown in FIG. 7, a work range in which the excavator 100S can perform work while avoiding contact with surrounding obstacles is a range underreaching a utility pole UP, which is an obstacle, and under a power line PL, which is an obstacle. In the example shown in FIG. 7, the work range of the excavator 100S includes a range under a ground surface ES. In this case, for example, the appropriate range AR is set on the boundary line of the work range of the excavator 100S and on the inner side of the boundary line, and on the boundary line of the movable range of the excavator 100S including the work attachment 101 and on the inner side of the boundary line.

At least one of the storage device 103 of the excavator 100S or the storage device 203 of the remote operation support device 200 stores thresholds Dth1 and Dth2 for determining whether or not the excavator 100S falls under an avoidance condition that should be avoided. These thresholds Dth1 and Dth2 are thresholds for determining that at least a part of the excavator 100S is included in a range in the vicinity of the boundary line of the work range of the excavator 100S, or in a range in the vicinity of the boundary line of the movable range of the excavator 100S.

That is, the range in the vicinity of the boundary line of the work range of the excavator 100S is, for example, a range that is within the work range of the excavator 100S and in which the distance from the boundary line of the work range is equal to or less than the thresholds Dth1 and Dth2. The range in the vicinity of the boundary line of the movable range of the excavator 100S is a range that is within the movable range of the excavator 100S and in which the distance from the boundary line of the movable range is equal to or less than the thresholds Dth1 and Dth2.

In the example shown in FIG. 7, the avoidance condition that should be avoided by the excavator 100S includes, for example, at least a part of the excavator 100S including the work attachment 101 being in the range in the vicinity of the boundary line of the work range of the excavator 100S, or being in the range in the vicinity of the boundary line of the movable range of the excavator 100S. In other words, the avoidance condition that should be avoided by the excavator 100S is a condition shown in FIG. 7, under which the distance between at least a part of the excavator 100S including the work attachment 101 and the boundary line of the appropriate range AR is equal to or less than the thresholds Dth1 and Dth2.

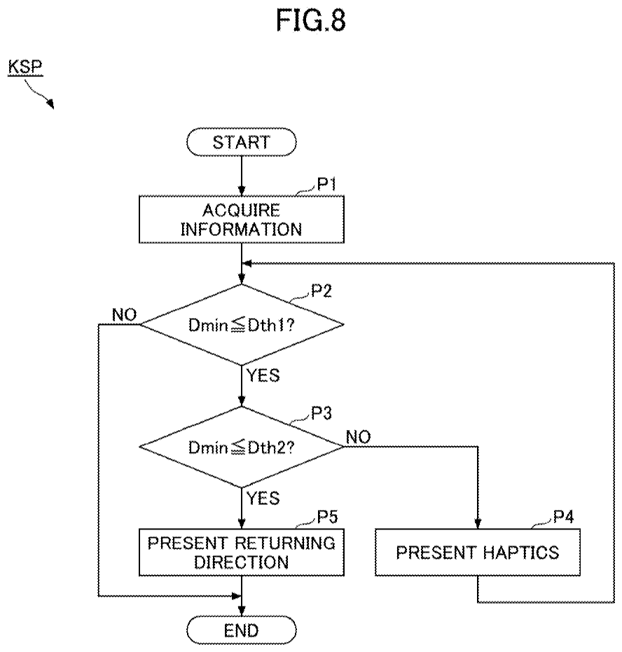

FIG. 8 is a flowchart showing an example of a haptics presentation processing flow KSP performed by the controller 30 of the excavator 100S as an example of the control device 107 of the work machine 100 shown in FIG. 1, or by the control device 201 of the remote operation support device 200. Hereinafter, for the sake of simplicity, “the controller 30 or the control device 201 as the control device 107” will be referred to as “the control device 107, 201”.

Upon starting the haptics presentation processing flow KSP shown in FIG. 8, the control device 107, 201 first acquires position/attitude information of the excavator 100S and an operation signal from the position/attitude detection device 102 and the operation device 104, 204 (information acquisition processing P1).

Next, the control device 107, 201 calculates the minimum distance Dmin between the excavator 100S including the work attachment 101 and the boundary line of the appropriate range AR based on the information acquired in the previous processing P1 and the information of the appropriate range AR stored in the storage device 103, 203. Further, the control device 107, 201 determines whether the minimum distance Dmin is equal to or less than a first threshold Dth1 stored in the storage device 103, 203 (determination processing P2).

When determining in the determination processing P2 that the minimum distance Dmin is greater than the threshold Dth1 (NO), that is, that the avoidance condition is not fallen under, the control device 107, 201 terminates the haptics presentation processing flow KSP of FIG. 8, and performs the haptics presentation processing flow KSP repeatedly at a predetermined cycle. On the other hand, when determining in the processing P2 that the minimum distance Dmin is equal to or less than the threshold Dth1 (YES), that is, that the avoidance condition is fallen under, the control device 107, 201 performs the next determination processing P3.

In the determination processing P3, the control device 107, 201 determines whether or not the minimum distance Dmin is equal to or less than the second threshold Dth2 stored in the storage device 103, 203. As the second threshold Dth2, for example, a value less than the first threshold Dth1 used in the first determination processing P2 may be used. When determining in the processing P3 that the minimum distance Dmin is greater than the threshold Dth2 (NO), the control device 107, 201 performs the next haptics presentation processing P4.

In the processing P4, the control device 107, 201 activates the haptics presentation device 105, 205. Here, for example, the control device 107, 201 uses the haptics presentation device 105, 205 to present, via the operation device 104, 204, haptics (operation reaction force) in a direction opposite to the direction in which the operator performs the operation that reduces the minimum distance Dmin. Here, for example, the control device 107, 201 may immobilize the movement of the operation device 104, 204 by the haptics presentation device 105, 205 to block the operation of the operator. Further, for example, the control device 107, 201 uses the haptics presentation device 105, 205 to present vibration via the operation device 104, 204.

More specifically, assume a case where, in the state shown in FIG. 7, the operator of the excavator 100S operates the operation device 104, 204 in the arm opening direction to pivot the arm 5 of the work attachment 101 upward, and, as a result, the minimum distance Dmin between the bucket 6, which is a part of the work attachment 101, and the boundary line of the appropriate range AR becomes equal to or less than the threshold Dth1.

Here, the operation device 104 of the excavator 100S via which the arm 5 is operated includes, for example, the left operation lever in the cabin 10, the left operation lever 104b of the portable controller 104A of FIG. 2, and the stick 104n of the joystick 104B of FIG. 3. Further, the operation device 204 of the remote operation support device 200 via which the arm 5 is operated includes, for example, the left operation lever installed in the remote operation chamber, the left operation lever 204b of the remote operation support device 200 shown in FIG. 2, and the stick 204n of the remote operation support device 200 shown in FIG. 3.

In this case, the haptics presentation device 105 of the excavator 100S uses, for example, the haptics presentation actuator 105b to present to the operator the haptics and vibration in the direction opposite to his/her operation direction, via the left operation lever in the cabin 10, the left operation lever 104b of the portable controller 104A, or the stick 104n of the joystick 104B. Further, the haptics presentation device 105 may use, for example, the haptics presentation actuator 105b to immobilize the movement of the left operation lever in the cabin 10, the left operation lever 104b of the portable controller 104A, or the stick 104n of the joystick 104B to block the inappropriate operation performed by the operator.

Similarly, the haptics presentation device 205 of the remote operation support device 200 uses, for example, the haptics presentation actuator 205b to present to the operator the haptics and vibration in the direction opposite to his/her operation direction, via the left operation lever in the remote operation chamber, the left operation lever 204b or the stick 204n of the remote operation support device 200. Further, the haptics presentation device 205 may use, for example, the haptics presentation actuator 205b to immobilize the movement of the left operation lever in the remote operation chamber, or the left operation lever 204b or the stick 204n of the remote operation support device 200 to block the inappropriate operation performed by the operator.

As a result, the operator can recognize that the excavator 100S has fallen under the avoidance condition that should be avoided, that is, can recognize that at least a part of the excavator 100S is in the range in the vicinity of the boundary line of the appropriate range AR, by the haptics presented via the operation device 104, 204. Therefore, the operator can stop the operation that reduces the minimum distance Dmin between the excavator 100S and the appropriate range AR, and prevent the excavator 100S from entering the range in the vicinity of the boundary line of the work range and the range in the vicinity of the boundary line of the movable range.

Thereafter, the control device 107, 201 repeats the processing P2 to P4 until the minimum distance Dmin between the excavator 100S and the boundary line of the appropriate range AR becomes greater than the threshold Dth1. Further, when determining in the processing P3 that the minimum distance Dmin between the excavator 100S and the appropriate range AR is equal to or less than the second threshold Dth2 (YES), the control device 107, 201 performs the next returning direction presentation processing P5.

In the processing P5, the control device 107, 201 presents to the operator via the operation device 104, 204, haptics in the returning direction in which the excavator 100S would overcome the avoidance condition. Specifically, the control device 107, 201 presents, to the operator via the operation device 104, 204, haptics in the direction in which the excavator 100S returns to the inner side of the range in the vicinity of the boundary line of the work range and of the range in the vicinity of the boundary line of the movable range by increasing the minimum distance Dmin from the appropriate range AR to become greater than the threshold Dth1.

More specifically, in the example described above, the haptics presentation device 105 of the excavator 100S uses, for example, the haptics presentation actuator 105b to present the haptics in the arm closing direction to the operator via the left operation lever in the cabin 10, the left operation lever 104b of the portable controller 104A, or the stick 104n of the joystick 104B.

Similarly, the haptics presentation device 205 of the remote operation support device 200 uses, for example, the haptics presentation actuator 205b to present the haptics in the arm closing direction to the operator via the left operation lever in the remote operation chamber, or the left operation lever 204b or the stick 204n of the remote operation support device 200.

Thus, an appropriate direction to operate the operation device 104, 204 can be presented to an inexperienced operator. Further, the control device 107, 201 may use, for example, the haptics presentation device 105, 205 to generate the haptics intermittently at a predetermined cycle in an arm bending direction via the operation device 104, 204 to present haptics like repeated nudges to the operator. This facilitates making the operator recognize the appropriate direction to operate the operation device 104, 204. Further, the avoidance condition, which is the condition of the position/attitude that should be avoided by the excavator 100S, includes, for example, variation in the position/attitude information due to a slip of the excavator 100S.

For example, in the example shown in FIG. 7, when the upper turning body 3 of the excavator 100S is caused to turn to press the bucket 6 of the work attachment 101 against the excavation surface from a side, a reaction force is applied to the upper turning body 3 from the excavation surface through the work attachment 101. This reaction force might cause the lower traveling body 1 of the excavator 100S to slip on the ground surface ES.

The control device 107, 201 detects the slip of the excavator 100S based on, for example, variation in position/attitude information acquired from the position/attitude detection device 102 and information acquired from various sensors of the excavator 100S. When detecting the slip of the excavator 100S, the control device 107, 201 activates the haptics presentation device 105, 205 to present haptics in the direction in which the excavator 100S slips to the operator via the operation device 104, 204.

Specifically, the control device 107, 201 activates the left and right pseudo haptics presentation actuators 105a, 205a of the haptics presentation device 105, 205 on the portable controller 104A of FIG. 2 constituting the operation device 104, 204 or on the remote operation support device 200. Then, the left and right pseudo haptics presentation actuators 105a, 205a present pseudo haptics in the mutually opposite forward and backward directions to the operator via the housing 104a, 204a.

Thus, haptics in the clockwise direction RHT or the counterclockwise direction LHT corresponding to the direction in which the excavator 100S slips can be presented to the operator via the housing 104a, 204a of the portable controller 104A or of the remote operation support device 200. As a result, the operator remotely operating the excavator 100S via the portable controller 104A or the remote operation support device 200 can easily recognize the slip of the excavator 100S. The left and right pseudo haptics presentation actuators 105a, 205a can make the operator recognize not only a slip of the excavator 100S in a rotational direction, but also a linear slip thereof.

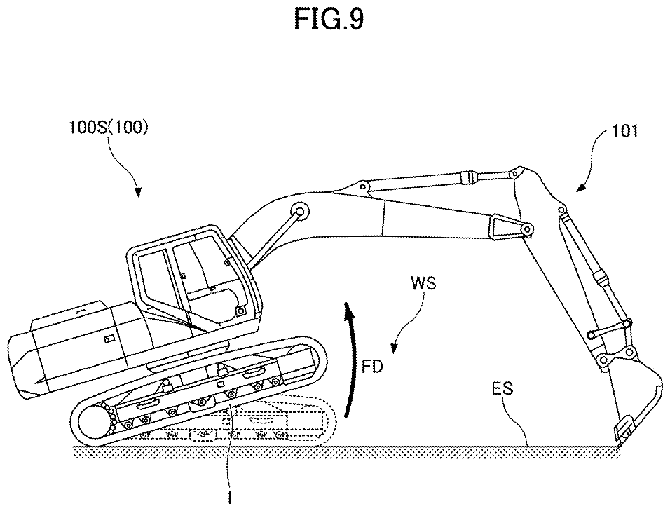

FIG. 9 is a side view showing another example of an avoidance condition that should be avoided by the excavator 100S shown in FIG. 4. As shown in FIG. 9, the excavator 100S, which is an example of the work machine 100 shown in FIG. 1, includes the lower traveling body 1 and the upper turning body 3 that is turnably mounted on the lower traveling body 1 and to which the work attachment 101 is attached. In the example shown in FIG. 9, the avoidance condition is a floating state of a part of the lower traveling body 1 due to the work attachment 101 applying a force to the ground surface ES, which is the excavation target.

The control device 107, 201 detects a jack-up, which is a floating state of a part of the lower traveling body 1, based on, for example, position/attitude information of the excavator 100S including the work attachment 101. The control device 107, 201 may detect a jack-up using, for example, a detection result of a bottom pressure sensor provided to at least one of the boom cylinder 7, the arm cylinder 8, or the bucket cylinder 9. The control device 107, 201 may detect a jack-up using, for example, an inclination angle of the ground surface ES recognized based on images captured by image capture devices C1.

For example, when a jack-up is detected, the control device 107, 201 determines that the excavator 100S falls under the avoidance condition, and activates the haptics presentation device 105, 205 to present haptics corresponding to the floating direction FD of the lower traveling body 1 to the operator via the operation device 104, 204.

Specifically, for example, the control device 107, 201 activates the front and back pseudo haptics presentation actuators 105a, 205a of the haptics presentation device 105, 205 on the portable controller 104A of FIG. 2 constituting the operation device 104, 204, or on the remote operation support device 200.

Then, the pseudo haptics presentation actuators 105a, 205a on the front part of the housing 104a, 204a present upward pseudo haptics to the operator via the front part of the housing 104a, 204a. On the other hand, the pseudo haptics presentation actuators 105a, 205a on the back part of the housing 104a, 204a present downward pseudo haptics to the operator via the back part of the housing 104a, 204a.

Thus, as shown in FIG. 2, haptics in the upward direction UT corresponding to the floating direction FD of the excavator 100S can be presented to the operator via the housing 104a, 204a of the portable controller 104A or the remote operation support device 200. As a result, the operator remotely operating the excavator 100S using the portable controller 104A or the remote operation support device 200 can easily recognize the jack-up of the excavator 100S.

Further, for example, the control device 107, 201 activates the haptics presentation actuator 105b, 205b of the haptics presentation device 105, 205 on the joystick 104B of FIG. 3 constituting the operation device 104, 204, or on the remote operation support device 200.

Then, the haptics presentation actuator 105b, 205b of the haptics presentation device 105, 205 presents to the operator via the stick 104n, 204n, haptics in a direction opposite to the direction in which the operator operates the stick 104n, 204n. Here, the haptics presentation actuator 105b, 205b may present, for example, vibration to the operator via the stick 104n, 204n. Further, the pseudo haptics presentation actuator 105a, 205a of the haptics presentation device 105, 205 may present to the operator, via the stick 104n, 204n, pseudo haptics in a direction opposite to the direction in which the operator operates the stick 104n, 204n.

Thus, it is possible to present pseudo haptics or haptics in a direction to avoid floating of the excavator 100S to the operator operating the excavator 100S using the portable controller 104A shown in FIG. 2 or the remote operation support device 200, or the joystick 104B shown in FIG. 3 or the remote operation support device 200.

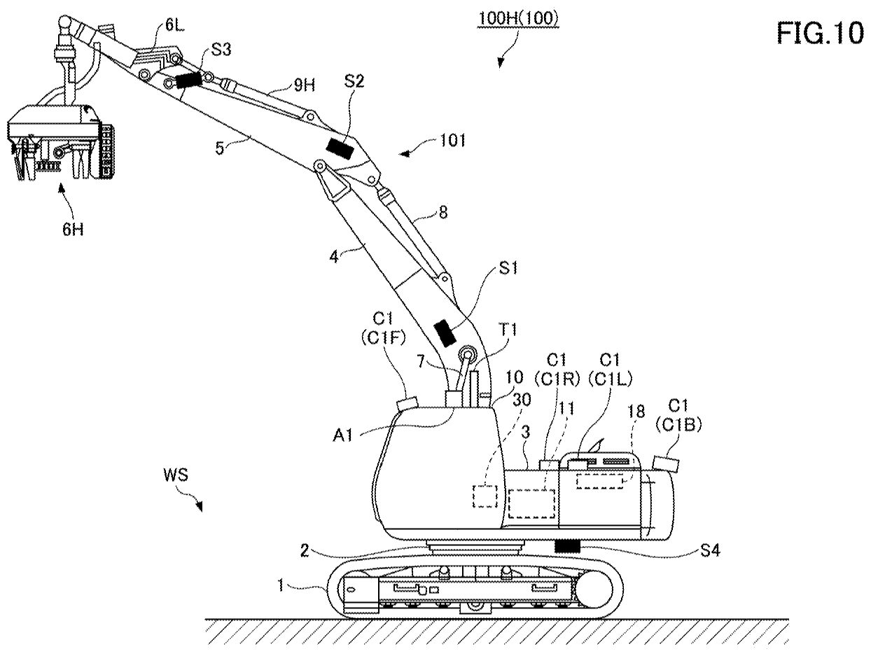

FIG. 10 is a side view of a forestry machine 100H as an example of the work machine 100 shown in FIG. 1. The forestry machine 100H shown in FIG. 10 is different from the excavator 100S shown in FIG. 4 mainly in that the end attachment constituting the work attachment 101 is changed from the bucket 6 to a roller harvester device 6H. Since the other configurational particulars of the forestry machine 100H shown in FIG. 10 are the same as those of the work machine 100 shown in FIG. 4, the same reference numerals are assigned to similar parts to omit description thereof.

Similarly to the excavator 100S, the forestry machine 100H includes the lower traveling body 1 and the upper turning body 3 that is turnably mounted on the lower traveling body 1 and to which the work attachment 101 is attached. The forestry machine 100H includes, for example, a harvester link 6L that is attached to the tip of the arm 5, which is a component of the work attachment 101, and the roller harvester device 6H attached to the tip of the harvester link 6L. The harvester link 6L is hydraulically driven by, for example, a harvester link cylinder 9H similar to the bucket cylinder 9. A guard is attached to the front of the cabin 10 to cover a window. The guard is openable and closable, and the guard is closed during bucking work in order to protect the worker from falling objects, such as dismantled materials, crushed stones, branches, and the like.

The roller harvester device 6H includes, for example, a gripping part for picking and gripping raw wood, a feeding part for feeding the raw wood (feeding the raw wood in the longer direction), a pruning part for pruning the raw wood together with feeding the raw wood, and a cutting part for cutting the raw wood into a desired length. The roller harvester device 6H includes a tilt part for changing the attitude of the main body (the angle with respect to a horizontal plane). The term “raw wood” refers to a state before being bucked as lumber by bucking work, and the term “lumber” refers to a state bucked from the raw wood by the bucking work.

For the forestry machine 100H, an avoidance condition includes position/attitude information indicating a possibility that raw wood might collide with the forestry machine 100H when, for example, the work attachment 101 gripping the raw wood feeds the raw wood in the longer direction or rotates the raw wood about a rotation axis in the vertical direction. Specifically, for the forestry machine 100H, an avoidance condition is a position and an attitude of the roller harvester device 6H from which raw wood gripped by the roller harvester device 6H would end up colliding with the cabin 10 when, for example, fed in the longer direction. For the forestry machine 100H, an avoidance condition is a position and an attitude of the roller harvester device 6H from which raw wood gripped by the roller harvester device 6H would end up colliding with the cabin 10 when, for example, the roller harvester device 6H is rotated about a rotation axis parallel with the vertical direction.

The avoidance condition, the predetermined length of the raw wood, and the like are previously stored in, for example, at least one of the storage device 103 of the forestry machine 100H as the work machine 100 shown in FIG. 1 or the storage device 203 of the remote operation support device 200. The length of the raw wood may be calculated by the control device 107, 201 or estimated by machine learning, using, for example, images of the raw wood captured by the image capture devices C1 or information of the raw wood acquired by LiDAR (laser radar).

For example, when position/attitude information of the work attachment 101 acquired from the position/attitude detection device 102 falls under the avoidance condition stored in the storage device 103, 203, the control device 107, 201 activates the haptics presentation device 105, 205 to present the haptics. For example, the control device 107, 201 activates the haptics presentation device 105, 205 to present the haptics corresponding to the feed direction of the raw wood or the rotation direction of the raw wood to the operator via the operation device 104, 204.

Specifically, for example, the control device 107, 201 operates the haptics presentation device 105, 205 to present haptics vibrating to the front and the back in the feed direction of the raw wood via the operation device 104, 204. Thus, it is possible to notify the operator that the raw wood gripped by the roller harvester device 6H might collide with the cabin 10 when it is fed in the longer direction.

Further, for example, the control device 107, 201 activates the haptics presentation device 105, 205 to present haptics vibrating in the rotation direction of the roller harvester device 6H via the operation device 104, 204. Thus, it is possible to notify the operator that the raw wood gripped by the roller harvester device 6H might collide with the cabin 10 when it is rotated about a rotation axis in the vertical direction. For example, the control device 107, 201 may generate a warning sound or provide a sound notification via the sound output device simultaneously with the presentation of the haptics via the operation device 104, 204.

As described above, the remote operation support system SYS for a work machine of the present embodiment includes the work machine 100 including the work attachment 101, and the remote operation support device 200 for remotely operating the work machine 100. The remote operation support system SYS for a work machine includes the position/attitude detection device 102, the storage device 103, 203, the operation device 104, 204, the haptics presentation device 105, 205, the drive device 106, and the control device 107, 201. The position/attitude detection device 102 detects position/attitude information of the work machine 100. The storage device 103, 203 stores the avoidance condition, which is the condition of a position/attitude that should be avoided by the work machine 100. The operation device 104, 204 generates an operation signal corresponding to the operation performed by the operator of the work machine 100. The haptics presentation device 105, 205 presents haptics to the operator via the operation device 104, 204. The drive device 106 moves the work machine 100 in accordance with the operation signal. The control device 107, 201 operates the haptics presentation device 105, 205 when the position/attitude information of the work machine 100 falls under the avoidance condition.

With this configuration, the remote operation support system SYS for a work machine of the present embodiment can activate the haptics presentation device 105, 205 by the control device 107, 201 when position/attitude information of the work machine 100 falls under a preset avoidance condition. Then, the haptics presentation device 105, 205 can present haptics to the operator via the operation device 104, 204 to notify that the position/attitude of the work machine 100 falls under the avoidance condition. Therefore, according to the remote operation support system SYS for a work machine of the present embodiment, when the work machine 100 falls under an avoidance condition, which is the condition of a position/attitude that should be avoided, the operator operating the operation device 104, 204 can be urged to perform an operation that would overcome the avoidance condition. Thus, for example, as shown in FIG. 7, it is possible to more reliably prevent the excavator 100S from moving out of the appropriate range AR to a range IR outside. Further, for example, it is possible to more reliably prevent raw wood gripped by the roller harvester device 6H of the forestry machine 100H shown in FIG. 10 from colliding with the cabin 10. Furthermore, unlike a case of bringing the work machine 100 to an emergency stop upon the work machine 100 falling under an avoidance condition, the operator would not be forced to suspend the work, or would not need to check the contents of a warning displayed on the display device by removing his/her line of sight from the work site WS. Therefore, even an inexperienced operator can improve the work efficiency. Furthermore, according to the remote operation support system SYS for a work machine of the present embodiment, it is possible to determine an avoidance condition without performing external field measurement by an external field sensor. Therefore, the device configuration and data processing can be simplified.

The work machine 100 of the present embodiment includes the work attachment 101. The work machine 100 includes the position/attitude detection device 102, the storage device 103, the operation device 104, the haptics presentation device 105, the drive device 106, and the control device 107. The position/attitude detection device 102 detects position/attitude information of the work machine 100. The storage device 103 stores an avoidance condition, which is the condition of a position/attitude that should be avoided by the work machine 100. The operation device 104 generates an operation signal corresponding to an operation performed by an operator of the work machine 100. The haptics presentation device 105 presents haptics to the operator via the operation device 104. The drive device 106 moves the work machine 100 in accordance with the operation signal. The control device 107 operates the haptics presentation device 105 when the position/attitude information of the work machine 100 falls under the avoidance condition.

With this configuration, the work machine 100 of the present embodiment can activate the haptics presentation device 105 by the control device 107 when position/attitude information of the work machine 100 falls under an avoidance condition set in advance. The haptics presentation device 105 can present haptics to the operator via the operation device 104 to notify that the position/attitude of the work machine 100 falls under the avoidance condition. Therefore, according to the work machine 100 of the present embodiment, when the work machine 100 falls under an avoidance condition, which is the condition of a position/attitude that should be avoided, the operator operating the operation device 104 can be urged to perform an operation that would overcome the avoidance condition. Thus, for example, as shown in FIG. 7, it is possible to more reliably prevent the excavator 100S from moving out of the appropriate range AR into a region IR outside. Furthermore, unlike a case of bringing the work machine 100 to an emergency stop upon the work machine 100 falling under the avoidance condition, the operator would not be forced to suspend the work, or would not need to check the contents of a warning displayed on the display device by removing his/her line of sight from the work site WS. Therefore, even an inexperienced operator can improve the work efficiency. Furthermore, according to the work machine 100 of the present embodiment, it is possible to determine an avoidance condition without performing external field measurement by an external field sensor. Therefore, the device configuration and data processing can be simplified.

In the work machine 100 of the present embodiment, the operation device 104 is, for example, the portable controller 104A shown in FIG. 2. The haptics presentation device 105 includes the pseudo haptics presentation actuators 105a mounted on the portable controller 104A and configured to present pseudo haptics in predetermined directions.

With this configuration, by using the portable controller 104A at the work site WS where the work machine 100 performs work, it is possible to operate the work machine 100 from the cabin 10 of the work machine 100 or to remotely operate the work machine 100 from outside the cabin 10. In addition, it is possible to cause the pseudo haptics presentation actuators 105a to generate pseudo haptics vibration in a desired direction and present pseudo haptics in the desired direction to the operator via the housing 104a. Thus, as shown in FIG. 2, it is possible to present pseudo haptics to the operator via the housing 104a of the portable controller 104A in the clockwise direction RHT, the counterclockwise LHT, the upward direction UT, the downward direction DT, the front-back direction, the left-right direction, or the vertical direction corresponding to the avoidance condition under which the work machine 100 falls.

In the remote operation support system SYS for a work machine of the present embodiment, the remote operation support device 200 can be configured as the portable controller as shown in FIG. 2. The haptics presentation device 205 includes the pseudo haptics presentation actuators 205a mounted on the remote operation support device 200 serving as the portable controller and configured to present pseudo haptics in a predetermined direction.

With this configuration, it is possible to remotely operate the work machine 100 by using the remote operation support device 200 serving as the portable controller at a remote location away from the work site WS where the work machine 100 performs work. In addition, it is possible to cause the pseudo haptics presentation actuators 205a to generate pseudo haptics vibration in a desired direction and present the pseudo haptics in the desired direction to the operator via the housing 204a. Thus, as shown in FIG. 2, it is possible to present pseudo haptics to the operator via the housing 204a in the clockwise direction RHT, the counterclockwise direction LHT, the upward direction UT, the downward direction DT, the front-back direction, the left-right direction, or the vertical direction corresponding to the avoidance condition under which the work machine 100 falls.

In the work machine 100 of the present embodiment, the operation device 104 is the joystick 104B. Further, the haptics presentation device 105 includes the haptics presentation actuator 105b for presenting haptics in a direction opposite to the direction in which the joystick 104B is operated by the operator of the work machine 100, or haptics in a direction in which the avoidance condition would be overcome.

With this configuration, by using the joystick 104B at the work site WS where the work machine 100 performs work, it is possible to operate the work machine 100 from the cabin 10 of the work machine 100, or to remotely operate the work machine 100 from outside the cabin 10. Further, the haptics presentation actuator 105b can present haptics in a desired direction to the operator via the stick 104n of the joystick 104B. Thus, it is possible to present to the operator via the joystick 104B, haptics in a direction opposite to the direction in which the operator performs the operation, or haptics in a direction in which the avoidance condition would be overcome, and to urge the operator to perform an operation that would overcome the avoidance condition.

Further, in the remote operation support system SYS for a work machine of the present embodiment, the remote operation support device 200 may be configured as the joystick as shown in FIG. 3. Further, the haptics presentation device 205 includes the haptics presentation actuator 205b for presenting haptics in a direction opposite to the direction in which the stick 204n is operated by the operator remotely operating the work machine 100, or haptics in a direction in which the avoidance condition would be overcome.

With such a configuration, it is possible to remotely operate the work machine 100, by using the remote operation support device 200 serving as the joystick at a remote location away from the work site WS where the work machine 100 performs work. Further, the haptics presentation actuator 205b can present haptics in a desired direction to the operator via the stick 204n of the operation device 204. As a result, it is possible to present haptics in a direction opposite to the direction in which the operator performs the operation, or haptics in a direction in which the avoidance condition would be overcome to the operator at the remote location via the operation device 204 of the remote operation support device 200, and to urge the operator to perform an operation that would overcome the avoidance condition.

Further, in the work machine 100 and the remote operation support system SYS for a work machine of the present embodiment, the avoidance condition includes at least a part of the work machine 100 including the work attachment 101 being in the range in the vicinity of the boundary line of the work range of the work machine 100 or in the range in the vicinity of the boundary line of the movable range of the work machine 100.

With this configuration, for example, as shown in FIG. 7, when at least a part of the work machine 100 enters the range in the vicinity of the appropriate range AR indicating the boundary line of the work range or the boundary line of the movable range of the work machine 100, the control device 107, 201 activates the haptics presentation device 105, 205. As a result, haptics is presented to the operator via the operation device 104, 204. Thus, the operator can recognize that at least a part of the work machine 100 is in the range in the vicinity of the boundary line of the work range of the work machine 100 or in the range in the vicinity of the boundary line of the movable range of the work machine 100.

Therefore, the operator can operate the operation device 104, 204 in a direction in which the work machine 100 would overcome the avoidance condition, that is, in a direction in which the work machine 100 moves away from the boundary line of the appropriate range AR indicating the boundary line of the work range and the boundary line of the movable range. In addition, unlike a case of bringing the work machine 100 to an emergency stop upon the work machine 100 moving out of the work range or the movable range, the operator would not be forced to suspend the work, or would not need to check the contents of a warning displayed on the display device by removing his/her line of sight from the work site WS. Therefore, even an inexperienced operator can improve the work efficiency.

Further, in the work machine 100 and the remote operation support system SYS for a work machine of the present embodiment, the avoidance condition includes variation in the position/attitude information due to a slip of the work machine 100. Further, the control device 107, 201 activates the haptics presentation device 105, 205 to present haptics in the direction in which the work machine 100 slips to the operator via the operation device 104, 204.

With this configuration, haptics corresponding to the direction in which the work machine 100 slips can be presented to the operator of the work machine 100 via the housing 104a of the portable controller 104A shown in FIG. 2 and the housing 204a of the remote operation support device 200 as the portable controller. Thus, the operator remotely operating the work machine 100 using the portable controller 104A or the remote operation support device 200 can easily recognize that the work machine 100 has slipped. As a result, the operator remotely operating the work machine 100 can perform an operation for returning the work machine 100 from the slipped state to the state before slipping.

As shown in FIGS. 4 to 9, the work machine 100 of the present embodiment is the excavator 100S including, for example, the lower traveling body 1 and the upper turning body 3 that is turnably mounted on the lower traveling body 1 and to which the work attachment 101 is attached. Further, an avoidance condition, which is the condition of a position/attitude that should be avoided by the excavator 100S, includes a floating state of a part of the lower traveling body 1 due to the work attachment 101 applying a force to the excavation target. Then, the control device 107, 201 activates the haptics presentation device 105, 205 to present haptics corresponding to the floating direction of the lower traveling body 1 to the operator via the operation device 104, 204.

With this configuration, for example, it is possible to present haptics in the upward direction UT corresponding to the floating direction of the excavator 100S to the operator via the housing 104a, 204a of the portable controller 104A shown in FIG. 2 or the remote operation support device 200. Further, for example, it is possible to present haptics in a direction opposite to the direction in which the operator performs the operation to the operator via the stick 104n, 204n of the joystick 104B shown in FIG. 3 or the remote operation support device 200. As a result, it is possible to force the operator remotely operating the work machine 100 to recognize the floating of the lower traveling body 1, and to urge the operator to perform an operation in a direction in which the avoidance condition would be overcome.

As shown in FIG. 10, the work machine 100 is the forestry machine 100H including, for example, the lower traveling body 1 and the upper rotating body 3 that is turnably mounted on the lower traveling body 1 and to which the work attachment 101 is attached. In addition, an avoidance condition that should be avoided by the forestry machine 100H includes position/attitude information that indicates a possibility that raw wood might collide with the forestry machine 100H when the work attachment 101 gripping the raw wood feeds the raw wood in the longer direction or rotates the raw wood about a rotation axis in the vertical direction. Then, the control device 107, 201 activates the haptics presentation device 105, 205 to present haptics corresponding to the feed direction of the raw wood or the rotation direction of the raw wood to the operator via the operation device 104, 204.

With this configuration, for example, it is possible to present haptics corresponding to the feed direction or the rotation direction of the raw wood gripped by the work attachment 101 to the operator via the housing 104a, 204a of the portable controller 104A shown in FIG. 2 or the remote operation support device 200. In addition, for example, it is possible to present haptics corresponding to the feed direction or the rotation direction of the raw wood gripped by the work attachment 101 to the operator via the stick 104n, 204n of the joystick 104B shown in FIG. 3 or the remote operation support device 20. As a result, it is possible to notify the operator of the work machine 100 of the risk of collision between the raw wood and the forestry machine 100H, and to urge the operator to perform an operation that would overcome the avoidance condition.

As described above, according to the present embodiment, it is possible to provide the work machine 100 and the remote operation support system SYS for a work machine, which can notify the operator of the work machine 100 of a situation that should be avoided by the work machine 100 including the work attachment 101 by presenting haptics regardless of the presence or absence of an obstacle.

The preferred embodiments of the present invention have been described in detail. However, the present invention is not limited to the above-described embodiments. Various modifications, substitutions, or the like are applicable to the above-described embodiments without departing from the scope of the present invention. Further, the separately described features may be combined as long as there is no technical conflict.

In the above-described embodiments, an example in which the work machine is an excavator has been described. However, the work machine according to the present disclosure is not limited to an excavator. When the work machine is a crane, for example, a boom swing exceeding a predetermined amplitude can be set as an avoidance condition. Thus, the haptics presentation device can present haptics corresponding to the boom swing to the operator via the operation device.

When the work machine is a crane, for example, a condition involving a risk of the crane tipping over can be set as an avoidance condition. Specifically, the avoidance condition may include, for example, conditions of the inclination angle of the upper turning body or the traveling body with respect to a horizontal plane, and the attitude of the boom or the jib as the work attachment. Thus, an inexperienced crane operator can intuitively perceive the possibility of the crane tipping over, and determine an appropriate operation.

Further, for example, when the work machine is an excavator, a crane, a wheel loader, or a forklift, overloading exceeding the rated load of the work attachment can be set as the avoidance condition. Thus, for example, the haptics presentation device can present to the operator via the operation device, haptics that makes the operator feel like being driven downward, or being pulled forward, which enables the operator to recognize the overload.

What is claimed is:

1. A work machine equipped with a work attachment, the work machine comprising:
a position/attitude detection device configured to detect. position/attitude information of the work machine;
a storage device configured to store an avoidance condition, which is a condition of a position/attitude that should be avoided by the work machine;
an operation device configured to generate an operation signal corresponding to an operation performed by an operator of the work machine;
a haptics presentation device configured to present haptics to the operator via the operation device;
a drive device configured to move the work machine in accordance with the operation signal; and
a controller including a processor and a memory and configured to activate the haptics presentation device when the position/attitude information falls under the avoidance condition.

2. The work machine according to claim 1,
wherein the operation device is a portable controller, and
the haptics presentation device includes a pseudo haptics presentation actuator mounted on the portable controller and configured to present pseudo haptics in a predetermined direction.

3. The work machine according to claim 1,
wherein the operation device is a joystick, and
the haptics presentation device includes a haptics presentation actuator configured to present haptics in a direction opposite to a direction in which the joystick is operated by the operator, or haptics in a direction in which the avoidance condition is overcome.

4. The work machine according to claim 1,
wherein the avoidance condition includes at least a part of the work machine including the work attachment being in a range in a vicinity of a boundary line of a work range of the work machine or in a range in a vicinity of a boundary line of a movable range of the work machine.

5. The work machine according to claim 2,
wherein the avoidance condition includes variation in the position/attitude information due to a slip of the work machine, and
the controller activates the haptics presentation device to present to the operator via the operation device, haptics in a direction in which the work machine slips.

6. The work machine according to claim 2,
wherein the work machine is an excavator including: a lower traveling body; and an upper turning body that is turnably mounted on the lower traveling body and to which the work attachment is attached,
the avoidance condition includes a floating state of a part of the lower traveling body caused by the work attachment applying a force to an excavation target, and
the controller activates the haptics presentation device to present haptics corresponding to a floating direction of the lower traveling body to the operator via the operation device.

7. The work machine according to claim 2,
wherein the work machine is a forestry machine including: a lower traveling body; and an upper turning body that is turnably mounted on the lower traveling body and to which the work attachment is attached,
the avoidance condition includes the position/attitude information indicating a possibility that raw wood might collide with the forestry machine when the work attachment gripping the raw wood feeds the raw wood in a longer direction or rotates the raw wood about a rotation axis in a vertical direction, and
the controller activates the haptics presentation device to present haptics corresponding to a feed direction of the raw wood or a rotation direction of the raw wood to the operator via the operation device.

8. A remote operation support system for a work machine, comprising: a work machine including a work attachment; and a remote operation support device configured to remotely operate the work machine,
the remote operation support system comprising:
a position/attitude detection device configured to detect position/attitude information of the work machine;
a storage device configured to store an avoidance condition, which is a condition of a position/attitude that should be avoided by the work machine;
an operation device configured to generate an operation signal corresponding to an operation performed by an operator of the work machine;
a haptics presentation device configured to present haptics to the operator via the operation device;
a drive device configured to move the work machine in accordance with the operation signal; and
a controller including a processor and a memory and configured to activate the haptics presentation device when the position/attitude information falls under the avoidance condition.
